(19) United States
(12) Patent Application Publication
(10) Pub. No.: US 2018/0114410 A1
(43) Pub. Date: Apr. 26, 2018

(54) Method of Playing a Blackjack Side Bet

(71) Applicant: Nicholas William Pelchar, Purcellville, VA (US)

(72) Inventor: Nicholas William Pelchar, Purcellville, VA (US)

(21) Appl. No.: 15/793,224

(22) Filed: Oct. 25, 2017

Related U.S. Application Data
(60) Provisional application No. 62/496,638, filed on Oct. 25, 2016.

(51) Int. Cl. G07F 17/32

(52) U.S. Cl. CPC G07F 17/3288; A63F 2001/003; G07F 17/3293

(57) ABSTRACT

A method of playing a blackjack side bet includes, in a blackjack game played by multiple players against a dealer, providing a side bet pot into which each player may place a side bet, and awarding the side bet pot to a player with highest points under twenty-two when a round of the game ends, wherein no hand of the dealer affects the side bet pot, and wherein the dealer cannot win the side bet pot. In implementations additional side bet pots are formed if two or more side-betting players tie for highest points under twenty-two at the end of a round. In implementations a percentage of each side bet pot is placed into a progressive pot that is won by one or more players receiving black jacks as their first two cards.

### CROSS REFERENCE TO RELATED APPLICATIONS

This document claims the benefit of the filing date of U.S. Provisional Patent Application No. 62/496,638, entitled “Side Bet for Blackjack Casino Game,” naming as first inventor Nicholas William Pelchar, which was filed on Oct. 25, 2016, the disclosures of each of which are hereby incorporated entirely herein by reference.

### BACKGROUND

### 1. Technical Field

Aspects of this document relate generally to games. Specific aspects of this document relate generally to card games.

### 2. Background Art

Card games of many varieties exist in the art, some of which are played in our out of casinos. Some card games involve monetary bets by which a player may win a certain amount or a pool of money if the game is won. Blackjack (sometimes called twenty-one) is a comparing card game in which multiple players compete against a dealer, but players do not play against one another.

### SUMMARY

Embodiments of methods of playing a blackjack side bet include: in a blackjack game (game) played by multiple players against a dealer, providing a side bet pot into which each player may place a side bet, and; awarding the side bet pot to a player with highest points under twenty-two when a round of the game ends; wherein no hand of the dealer affects the side bet pot, and wherein the dealer cannot win the side bet pot.

Embodiments of methods of playing a blackjack side bet may include: in a blackjack game (game) played by multiple players against a dealer representing a house, providing a first side bet pot into which each player may place a side bet; if two or more players tie for highest points under twenty-two when a first round of the game ends, providing a second side bet pot into which each player may place a side bet in a second round; if two or more players tie for highest points under twenty-two when the second round ends, providing a third side bet pot into which each player may place a side bet in a third round, and; if any player has highest points under twenty-two when any round ends, awarding that player all the side bet pots; wherein no hand of the dealer affects any of the side bet pots, and wherein the dealer cannot win any of the side bet pots.

Embodiments of methods of playing a blackjack side bet may include one or more or all of the following:

Each side bet placed by a player may be required to be equal to or less than a base bet placed by the same player against the dealer that round.

No player may be allowed to place a side bet in a round in which that player has not placed a base bet against the dealer.

Each player who plays a base bet against the dealer may be required to place a side bet that round.

If two or more players tie for highest points under twenty-two when a round ends, any tied player may be allowed to withdraw that player's side bet and to not play a subsequent round.

A percentage (rake) of each side bet pot may be given to the house.

In embodiments, if a player hand is split, that player must place an additional side bet that round equal to that player's previously placed side bet.

Splitting may be only allowed twice (creating up to three hands) for each player.

Aces may only be allowed to be split once, with only one additional card dealt on each split.

A percentage of each side bet pot may be placed in a progressive pot.

The progressive pot may be won by a player who has placed a side bet and whose first two cards are matching black jacks in a round in which the dealer's first two cards are also matching blackjacks.

The progressive pot may be equally split between two or more players each of whose first two cards are matching black jacks in a round in which each has placed a side bet.

A percentage less than 50% of the progressive pot may be won by any player who has placed a side bet and whose first two cards are non-matching black jacks in a round in which the dealer's first two cards are also non-matching black jacks.

A percentage less than 50% of the progressive pot may be equally split between two or more players each of whose first two cards are non-matching black jacks in a round in which each has placed a side bet.

If two or more players tie for highest points under twenty-two when the third round ends, all of the side bet pots may be divided equally among tied players.

Embodiments of methods of playing a blackjack side bet may include: in a blackjack game (game) played by multiple players against a dealer, providing a first side bet pot into which each player who has placed a base bet against the dealer may place a side bet of equal or lesser value; if two or more players tie for highest points under twenty-two when a first round of the game ends, providing a second side bet pot into which each player who has placed a base bet against the dealer in the second round may place a side bet of equal or lesser value; if two or more players tie for highest points under twenty-two when the second round ends, providing a third side bet pot into which each player who has placed a base bet against the dealer in the third round may place a side bet of equal or lesser value, and; if any player has highest points under twenty-two when a round ends, awarding that player all the side bet pots; wherein no hand of the dealer affects any of the side bet pots, and wherein the dealer cannot win any of the side bet pots.

Embodiments of methods of playing a blackjack side bet may include one or more or all of the following:

Each player who plays a base bet against the dealer may be required to place a side bet that round.

If two or more players tie for highest points under twenty-two when a round ends, any tied player may be allowed to withdraw that player's side bet and to not play a subsequent round.

If two or more players tie for highest points under twenty-two when the third round ends then tied players may equally split all the side bet pots.

General details of the above-described embodiments, and other embodiments, are given below in the DESCRIPTION, the DRAWINGS, and the CLAIMS.

### BRIEF DESCRIPTION OF THE DRAWINGS

Embodiments will be discussed hereafter using reference to the included drawings, briefly described below, wherein like designations refer to like elements:

FIG. 1 is a top view of an implementation of a side bet for blackjack casino game.

### DESCRIPTION

Implementations/embodiments disclosed herein (including those not expressly discussed in detail) are not limited to the particular components or procedures described herein. Additional or alternative components, assembly procedures, and/or methods of use consistent with the intended side bet for blackjack casino game may be utilized in any implementation. This may include any materials, components, sub-components, methods, sub-methods, steps, and so forth.

The card games described herein are intended to be played using traditional 52-card decks with cards having values numbered 1 through 10 plus jack, queen, king, and ace, having traditional suits, i.e., clubs, spades, diamonds, and hearts. For the purposes of this disclosure clubs and spades are considered “black suits” and diamonds and hearts are considered “red suits,” for convenience of description, even if the actual color of the cards (or of the suit designations of the cards) is not black or red, respectively, for the actual cards used in any specific game. For example, if a deck were used in which the clubs and spades are colored green instead of black, and in which the hearts and diamonds are colored blue, for the purposes of this disclosure the clubs and spades would nevertheless be considered “black suits” and the hearts and diamonds would be considered “red suits” for purposes of this disclosure.

Furthermore, when a player receives two jacks of black suits, i.e., two blacks each of which is either a club or a spade, those are “black jacks” or “blackjacks” for the purposes of this disclosure. For example, matching jacks of spades, matching jacks of clubs, or one jack of spades and one jack of clubs, would all be “blackjacks” or “black jacks” for the purposes of this disclosure. Furthermore, black jacks of matching suit are considered “matching black jacks” or “matching blackjacks,” while black jacks of non-matching suit are considered “non-matching blackjacks” or “non-matching blackjacks,” for purposes of this disclosure. Accordingly, when a player receives as his first two cards a jack of spades and a jack of clubs, that player has received non-matching black jacks, whereas when a player receives as his first two cards either two jacks of spades or two jacks of clubs that player has received matching black jacks.

Traditionally, blackjack (sometimes called twenty-one) is a comparing card game in which multiple players compete against a dealer, but players do not play against one another. In blackjack the objective is to beat the dealer in one of the following ways: (1) get 21 points on the player's first two cards (sometimes called a “blackjack” or “natural”) without the dealer having a blackjack; (2) reaching a final score higher than the dealer without exceeding 21 points; or (3) the dealer drawing additional cards until his hand exceeds 21 points.

At casino blackjack tables a dealer generally faces five to seven players from behind a semicircular table and play includes shuffling one to eight standard 52-card decks together. As each round begins, up to three players can place bets in a betting box at each position in play. There may be up to three players at each position at a table in jurisdictions which allow back betting. The player whose bet is at the front of the betting box has control over the position, and the dealer consults the controlling player for playing decisions regarding the hand (other players “play behind”). Any player is generally allowed to control or bet in as many boxes as desired at a single table, but it is prohibited to play on more than one table at a time or to place multiple bets in a single box. In some U.S. casinos players are limited to playing two or three positions at a table and only one person is allowed to bet on each position.

The dealer deals from his left. Each box is dealt an initial hand of two cards visible to the people playing on it (sometimes visible to any other players). The dealer receives his first card face up (and in some “hole card” games immediately receives his second card, the “hole card,” face down), which the dealer views but does not reveal unless it makes the dealer's hand a blackjack. In “no hole card” games the dealer's second card is not drawn or viewed until the players have all played their hands.

Single cards are dealt to each wagered-on position clockwise from the dealer's left, followed with a single card to the dealer, followed by one additional card to each position in play. Players' initial cards may be dealt face up or face down.

The players try to win money by creating card totals higher than the dealer's hand that do not exceed 21 (called “busting” or “breaking”), or by the dealer busting. On each player's turn, the player must decide whether to take an additional card (“hit”), end their turn (“stand”), take a single card and finish with a double wager (“double”), separate two cards of the same value into two hands (“split”), or give up a half-bet and retire from the game (“surrender”). Number cards count as their number value, face cards (jack, queen, king) count as 10, and aces count as 1 or 11 as chosen by the player. If the hand value exceeds 21 it busts and all bets on it are immediately forfeit.

After all boxes are finished playing the dealer draws until the dealer either busts or achieves 17 or higher. The dealer does not double, split, or surrender. If the dealer busts all remaining player hands win. If the dealer does not bust each remaining bet wins if its hand is higher than the dealer's and loses if its hand is lower than the dealer's. In some cases a dealer is required to stand on all totals of 17 or higher. If a player has 21 on the first and second card it is a “natural” or “blackjack” and the player is paid out immediately unless the dealer also has 21, which results in a tie. In the case of tied scores, known as a “push” or “standoff,” bets are returned without adjustment, but a blackjack beats any hand (even a hand of 21) that is not a blackjack. Wins are generally paid out at 1:1, or equal to the wager, though sometimes winning player blackjacks are paid at 3:2 (three dollars for every two bet). In some casinos blackjacks are paid out at less than 3:2 (for example some pay out blackjacks at 6:5).

Traditional blackjack games sometimes provide a side bet called insurance, which may be played when the dealer's upcard is an ace. Other side bets are sometimes available such as a “dealer match” which pays when the player's cards match the dealer's up card.

Other details of traditional blackjack games are described in Appendix A, submitted herewith, the disclosure of which is incorporated herein in its entirety.

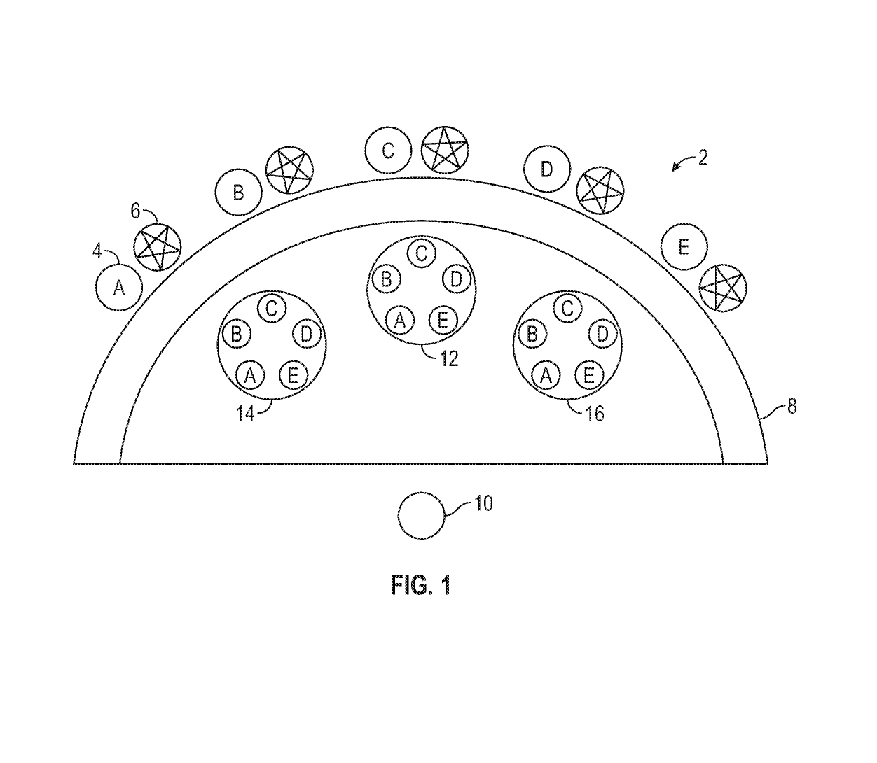

The present invention will now be described in detail. Referring to FIG. 1, a top view of an implementation of a side bet for blackjack casino game (side bet game) 2 is shown. A blackjack table 8 is represented in traditional semicircle shape and the dealer is behind this table facing, in the representative example, five players. The dealer's hand 10 is represented and the player hands 4 are represented by the letters A, B, C, D, E. Naturally, as with traditional blackjack games, the number of players may be some number other than five, and FIG. 1 is only meant to representatively illustrate the play of one implementation of the side bet game. The dealer hand and the player hands are actually on the table but they are illustrated off the table only for ease of illustrating the elements of the side bet game.

A traditional game of blackjack is played by the players against the dealer, but alongside this game the side bet game 2 is played. The side bet game allows players to bet head to head against one another while also playing their hands against the dealer in the traditional manner.

Each player may place a base bet 6 in their play against the dealer as previously described (the base bets are represented by stars in FIG. 1—these are actually the “betting boxes” which are on the table but are illustrated off the table so that the side bet pots can be easier illustrated). Each player may place a side bet into a first side bet pot (first pot) (first purse) 12, the side bet being equal in value to the base against the dealer and according to applicable game limits (the side bets being representatively illustrated by matching player indicators A, B, C, D, E). In some implementations of side bet games the players may be required to place a side bet if a base bet is played (the side bet in that case being of equal value to the base bet), in other implementations the side bet may be optional. In still other implementations a side bet may be played even if no base bet is wagered against the dealer. In implementations the side bet could be allowed to be of a different value than the base bet—in most cases it is anticipated that the side bet would be required to be equal or less than the base bet.

The first pot is shown in an area directly in front of the dealer in FIG. 1. At the end of the round the player or players with the better hand (according to normal blackjack rules) wins the side bet and gets the first purse. In other words, the normal blackjack play determines whether any player beats the dealer's hand, and the side bet play does not involve the dealer's hand but only determines who wins the side bet between the players.

If the side bet results in a tie by two or more players then a second side bet pot (second pot) (second purse) 14 is created to the left of the center pot (first pot) from the dealer's side and this pot is used for the side bet for the next round. At this point any player involved in the tie can request their share of the pot if they do not wish to play the next hand of blackjack. For those players that do not request their share, if there is an additional tie the next round a third side bet pot (third pot) (third purse) 16 is formed at the right of the center pot from the dealer's side and this pot is used for the side bet for the next round. At this point any player can request their share of the pot if they don't wish to play the next hand or round. Any ties beyond the second and third pots result in the players sharing equally the pot. In any round in which a player wins the side bet and does not tie with another player, that player wins all the first, second, and third pot.

During normal blackjack play a split hand can occur if a player's first two cards are of equal value (as described above). If a player chooses to split his hand he must add an additional side bet alongside the original side bet. In implementations this must be of equal value to the original side bet. In some implementations only splitting twice (creating three hands) is allowed in the side bet game. In some implementations aces can only be split once, with only one additional card being dealt on each split.

Because the house (casino) is not a player in the side bet game it cannot win any of the side bet pots, though a “rake” or small portion of the side bet pots (according to industry standards) may be taken by the casino to facilitate the game. In implementations an additional amount equal to the rake is taken from the pot, when the pot or pots are paid, to be placed by the Casino into a progressive pot. Any player that plays the side bet is eligible to win the progressive pot. The Casino can establish whether to contribute a starting amount to the progressive pot or only to contribute to it from the first through third pots when a payout occurs.

The progressive pot is won when: the dealer and one or more players receive on their first two cards two matching suits of either blackjacks; or two players receive on their first two cards two matching suits of either blackjacks. In either case the progressive pot is split between the winning players. In the implementations herein the suited pairs of jacks must be spades or clubs, i.e., black suits or “black jacks” (such a variant may be played, for example, under the name “Black Jack's Booty”) as described above, but the jacks do not need to be matching between players (for example a player may receive two jacks of spades and the dealer two jacks of clubs and that player would win the progressive pot because he has received matching black jacks as his first two cards and the dealer also received matching black jacks as his first two cards.

In other implementations the game may require the matching black jacks to be matching between player and dealer or between player and player (for example each receives two jacks of clubs as his first two cards or each receives two jacks of spades as his first two cards) for the progressive pot to be won—or a higher percentage of the pot may be won (for example all of the pot minus the rake) when the jacks are matching between players and a lesser percentage between 50 and 100 percent when the jacks are not matching between players (for example one player receives jacks of clubs as his first two cards and another player receives jacks of spades as his first two cards).

In some implementations a lesser percentage of the progressive pot, less than 50%, may be won by any player who receives on his first two cards black jacks of non-matching suit in a round in which the dealer or another player also receives on his first two cards black jacks of non-matching suit. In some implementations the percentage of the pot for such a win is between 5% and 20%, and in other implementations the percentage is 10%. In such a case if one player and one dealer each have the non-matching black jacks on their first two cards then the player gets the full lesser percentage of the progressive pot, whereas if one or more players each receive non-matching black jacks on their first two cards then the players divide the lesser percentage equally.

In some implementations there is only one spot for each player. In other words, at a table allowing, by non-limiting example, 3-5 players, each player can only play one spot. Because the game described herein allows players to play against one another in addition to against the dealer, allowing any player to play more than one spot would change the dynamics of the game. When a player splits, as described herein, that player is still only playing on one spot.

Although the side bet game is described as being played in a casino setting, naturally the game may be played in other settings and outside a casino or not involving a casino.

In places where the description above refers to specific embodiments of side bet for blackjack casino games, one or more or many modifications may be made without departing from the spirit and scope thereof. Details of any specific embodiment/implementation described herein may, wherever possible, be applied to any other specific implementation/embodiment described herein.

What is claimed is:

1. A method of playing a blackjack side bet, comprising:
in a blackjack game (game) played by multiple players against a dealer, providing a side bet pot into which each player may place a side bet, and;
awarding the side bet pot to a player with highest points under twenty-two when a round of the game ends;
wherein no hand of the dealer affects the side bet pot, and wherein the dealer cannot win the side bet pot.

2. A method of playing a blackjack side bet, comprising:
in a blackjack game (game) played by multiple players against a dealer representing a house, providing a first side bet pot into which each player may place a side bet;
if two or more players tie for highest points under twenty-two when a first round of the game ends, providing a second side bet pot into which each player may place a side bet in a second round;
if two or more players tie for highest points under twenty-two when the second round ends, providing a third side bet pot into which each player may place a side bet in a third round, and;
if any player has highest points under twenty-two when any round ends, awarding that player all the side bet pots;
wherein no hand of the dealer affects any of the side bet pots, and wherein the dealer cannot win any of the side bet pots.

3. The method of claim 2, wherein each side bet placed by a player must be equal to or less than a base bet placed by the same player against the dealer that round.

4. The method of claim 2, wherein no player may place a side bet in a round in which that player has not placed a base bet against the dealer.

5. The method of claim 2, wherein each player who plays a base bet against the dealer is required to place a side bet that round.

6. The method of claim 2, further comprising, if two or more players tie for highest points under twenty-two when a round ends, allowing any tied player to withdraw that player's side bet and to not play a subsequent round.

7. The method of claim 2, wherein a percentage (rake) of each side bet pot is given to the house.

8. The method of claim 2, wherein, if a player hand is split, that player must place an additional side bet that round equal to that player's previously placed side bet.

9. The method of claim 8, wherein splitting is only allowed twice (creating up to three hands) for each player.

10. The method of claim 8, wherein aces may only be split once, with only one additional card dealt on each split.

11. The method of claim 2, wherein a percentage of each side bet pot is placed in a progressive pot.

12. The method of claim 11, wherein the progressive pot is won by a player who has placed a side bet and whose first two cards are matching black jacks in a round in which the dealer's first two cards are also matching black jacks.

13. The method of claim 11, wherein the progressive pot is equally split between two or more players each of whose first two cards are matching black jacks in a round in which each has placed a side bet.

14. The method of claim 11, wherein a percentage less than 50% of the progressive pot is won by any player who has placed a side bet and whose first two cards are non-matching black jacks in a round in which the dealer's first two cards are also non-matching blackjacks.

15. The method of claim 11, wherein a percentage less than 50% of the progressive pot is equally split between two or more players each of whose first two cards are non-matching black jacks in a round in which each has placed a side bet.

16. The method of claim 2, wherein, if two or more players tie for highest points under twenty-two when the third round ends, all of the side bet pots are divided equally among tied players.

17. A method of playing a blackjack side bet, comprising:
in a blackjack game (game) played by multiple players against a dealer, providing a first side bet pot into which each player who has placed a base bet against the dealer may place a side bet of equal or lesser value;
if two or more players tie for highest points under twenty-two when a first round of the game ends, providing a second side bet pot into which each player who has placed a base bet against the dealer in the second round may place a side bet of equal or lesser value;
if two or more players tie for highest points under twenty-two when the second round ends, providing a third side bet pot into which each player who has placed a base bet against the dealer in the third round may place a side bet of equal or lesser value, and;
if any player has highest points under twenty-two when a round ends, awarding that player all the side bet pots;
wherein no hand of the dealer affects any of the side bet pots, and wherein the dealer cannot win any of the side bet pots.

18. The method of claim 17, wherein each player who plays a base bet against the dealer is required to place a side bet that round.

19. The method of claim 17, further comprising, if two or more players tie for highest points under twenty-two when a round ends, allowing any tied player to withdraw that player's side bet and to not play a subsequent round.

20. The method of claim 17, wherein, if two or more players tie for highest points under twenty-two when the third round ends then tied players equally split all the side bet pots.
